(19) United States
(12) Patent Application Publication
(10) Pub. No.: US 2023/0144368 A1
(43) Pub. Date: May 11, 2023

(54) STORAGE DEVICE, OPERATING METHOD OF STORAGE DEVICE, AND STORAGE SYSTEM

(71) Applicant: SAMSUNG ELECTRONICS CO., LTD., Suwon-Si (KR)

(72) Inventors: GYEONGMIN NAM, SUWON-SI (KR); CHANHA KIM, SUWON-SI (KR); SEUNGRYONG JANG, SUWON-SI (KR)

(21) Appl. No.: 17/973,071

(22) Filed: Oct. 25, 2022

(30) Foreign Application Priority Data
Nov. 10, 2021 (KR) 10-2021-0154278
Apr. 11, 2022 (KR) 10-2022-0044643

(51) Int. Cl. G06F 3/06

(52) U.S. Cl. CPC G06F 3/0613; G06F 3/0679; G06F 3/0659

(57) ABSTRACT

A storage device includes a nonvolatile memory and a controller. The controller is configured to insert, into a hot list, a portion of a logical address received from a host and manage a hot hash table storing a position, at which the logical address is inserted into the hot list. The controller is further configured to search the hot hash table for the position, at which the logical address is inserted into the hot list, by using the logical address, determine an attribute of data corresponding to the logical address based on the search result, and store attribute information indicating the attribute of the data.

### CROSS-REFERENCE TO RELATED APPLICATIONS

A claim of priority under 35 U.S.C. § 119 is made to Korean Patent Application Nos. 10-2021-0154278, filed on Nov. 10, 2021, and 10-2022-0044643, filed on Apr. 11, 2022, in the Korean Intellectual Property Office, the disclosures of which are incorporated by reference herein in their entireties.

### BACKGROUND

The inventive concept relates to a storage device, and more particularly, to a storage device for determining an attribute of data by using a hash table.

A flash memory device is popularly used as a voice and image data storage medium in information devices, such as a personal computer (PC), a smartphone, a personal digital assistant (PDA), a digital camera, a camcorder, a voice recorder, an MP3 player, and a handheld PC. Recently, to improve a degree of integration of a flash memory device, semiconductor memory devices having a three-dimensional array structure have been distributed. A cell string of flash memory having the three-dimensional array structure is stacked in a direction perpendicular to a substrate. That is, memory cells are provided on a substrate along rows and columns, and are stacked in a direction perpendicular to the substrate, thereby forming a three-dimensional structure.

A storage device using a flash memory device may identify and manage attributes of stored data as hot data and cold data to increase the efficiency of garbage collection. Hot data denotes data in which an update frequency is relatively high, and cold data denotes data in which an update frequency is relatively low. By identifying and managing hot data and cold data, the number of page copies occurring during garbage collection of a memory block may be reduced.

In this case, the storage device may manage hot data by storing, in a list, a logical address corresponding to a region in which the hot data is stored. Upon receiving an input/output request including a logical address from a host, the storage device may determine, by using the list, whether an attribute of data corresponding to the input/output request is hot. In this case, the storage device may sequentially search the list for addresses to determine whether the logical address included in the input/output request is in the list, thereby determining the attribute of the data. However, because this method sequentially searches the list for addresses, the larger the size of the list, the more time that is expended to determine an attribute of data. That is, a data attribute determining speed of the storage device is lowered as the size of the address list increases. This slows the overall performance of the storage device.

### SUMMARY

According to an aspect of the inventive concept, there is provided a storage device including: a nonvolatile memory; and a controller configured to insert, into a hot list, a portion of a logical address received from a host and manage a hot hash table storing a position, at which the logical address is inserted into the hot list, wherein the controller is further configured to search the hot hash table for the position, at which the logical address is inserted into the hot list, by using the logical address, determine an attribute of data corresponding to the logical address based on the search result, and store attribute information indicating the attribute of the data.

According to another aspect of the inventive concept, there is provided an operating method of a storage device including a nonvolatile memory and a controller, the operating method including: receiving a logical address from a host under control of the controller; searching a hot hash table for a position, at which the logical address is inserted into a hot list, by using the logical address under control of the controller; determining an attribute of data corresponding to the logical address based on the search result under control of the controller; and storing attribute information indicating the attribute of the data under control of the controller.

According to another aspect of the inventive concept, there is provided a storage system including: a storage device including a nonvolatile memory and a controller configured to manage a hot list and a hot hash table; and a host configured to transmit a logical address to the storage device, wherein the controller is further configured to search the hot hash table for a position, at which the logical address is inserted into the hot list, by using the logical address, determine an attribute of data corresponding to the logical address based on the search result, and store attribute information indicating the attribute of the data.

### BRIEF DESCRIPTION OF THE DRAWINGS

Embodiments of the inventive concept will be more clearly understood from the detailed description that follows, taken in conjunction with the accompanying drawings, in which:

FIG. 1 is a block diagram illustrating a storage system according to an embodiment of the inventive concept;

FIG. 2 is a diagram for reference in describing a hot list and a candidate list according to an embodiment of the inventive concept;

FIG. 3 a diagram for reference in describing a hash table according to an embodiment of the inventive concept;

FIG. 4 is a diagram for reference in describing the hot list and a hot hash table according to an embodiment of the inventive concept;

FIG. 5 is a diagram for reference in describing the candidate list and a candidate hash table according to an embodiment of the inventive concept;

FIG. 6 is a flowchart illustrating an operating method of a storage device, according to an embodiment of the inventive concept;

FIG. 7 is a flowchart illustrating a method, performed by a storage device, of determining an attribute of data corresponding to a received logical address, according to an embodiment of the inventive concept;

FIG. 8 is a flowchart illustrating a method, performed by a storage device, of updating a hot list or a candidate list, according to an embodiment of the inventive concept;

FIG. 9 is a flowchart illustrating a method, performed by a storage device, of updating a hot hash table when a received logical address is in a hot list, according to an embodiment of the inventive concept;

FIG. 10 is a flowchart illustrating a method, performed by a storage device, of updating a hot hash table and a candidate hash table when a received logical address is in a candidate list, according to an embodiment of the inventive concept;

FIG. 11 is a flowchart illustrating a method, performed by a storage device, of updating a candidate hash table when a received logical address is neither in a hot list nor in a candidate list, according to an embodiment of the inventive concept; and

FIG. 12 is a block diagram illustrating an electronic device according to an embodiment of the inventive concept.

### DETAILED DESCRIPTION OF THE EMBODIMENTS

Hereinafter, embodiments of the inventive concept are described in detail with reference to the accompanying drawings.

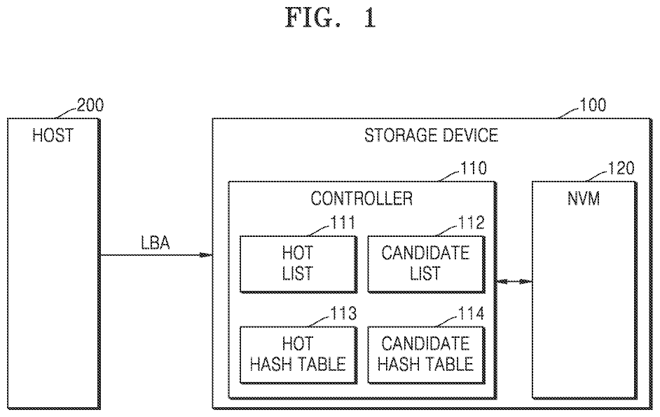

FIG. 1 is a block diagram illustrating a storage system according to an embodiment of the inventive concept.

Referring to FIG. 1, the storage system according to an embodiment of the inventive concept may include a storage device 100 and a host 200.

In an embodiment of the inventive concept, the storage system may be implemented by a personal computer (PC), a data server, a network-connected storage, an Internet of Things (IoT) device, or a portable electronic device. The portable electronic device may be any one of a laptop computer, a mobile phone, a smartphone, a tablet PC, a personal digital assistant (PDA), an enterprise digital assistant (EDA), a digital still camera, a digital video camera, an audio device, a portable multimedia player (PMP), a personal navigation device (PND), an MP3 player, a handheld game console, an e-book, a wearable device, and the like.

The storage device 100 may be an internal memory embedded in an electronic device. For example, the storage device 100 may be a solid state drive (SSD), an embedded universal flash storage (UFS) memory device, or an embedded multimedia card (eMMC). In some embodiments, the storage device 100 may be an external memory attachable to and detachable from an electronic device. For example, the storage device 100 may be a UFS memory card, a compact flash (CF) memory card, a secure digital (SD) memory card, a micro secure digital (Micro-SD) memory card, a mini secure digital (Mini-SD) memory card, an extreme digital (xD) memory card, or a memory stick.

The storage device 100 may include a controller 110 and a nonvolatile memory (NVM) 120.

The controller 110 may control the NVM 120. The controller 110 may write data on the NVM 120 or read data stored in the NVM 120, based on a request received from the host 200. In this case, the controller 110 may receive, from the host 200, a logical address LBA corresponding to a physical address of the NVM 120, at which the data is to be written or read, together with the request.

The controller 110 may manage a hot list 111, a candidate list 112, a hot hash table 113, and a candidate hash table 114 based on the logical address LBA received from the host 200.

The hot list 111 is a list in which a logical address LBA corresponding to a physical address at which hot data of which an attribute is hot is stored is inserted. Hot data may have a relatively high access frequency for write or read from the host 200. The controller 110 may determine whether an attribute of data corresponding to a logical address LBA is hot, by determining whether the logical address LBA is in the hot list 111.

The candidate list 112 is a list in which a logical address LBA at which warm data of which an attribute is warm is stored is inserted. Warm data may have an intermediate access frequency for write or read from the host 200. The controller 110 may determine whether an attribute of data corresponding to a logical address LBA is warm, by determining whether the logical address LBA is in the candidate list 112.

In addition, the controller 110 may determine an attribute of data corresponding to a logical address LBA is cold, when the logical address LBA is neither in the hot list 111 nor in the candidate list 112. Cold data may have a relatively low access frequency for write or read from the host 200.

The hot hash table 113 may store a position, at which a logical address LBA is inserted into the hot list 111. The controller 110 may search the hot hash table 113 to retrieve the position, at which the logical address LBA is inserted. In addition, the controller 110 may determine whether the logical address LBA is in the hot list 111, by determining whether the position, at which the logical address LBA is inserted, is retrieved from the hot hash table 113.

The candidate hash table 114 may store a position, at which the logical address LBA is stored in the candidate list 112. The controller 110 may search the candidate hash table 114 to retrieve the position, at which the logical address LBA is inserted. In addition, the controller 110 may determine whether the logical address LBA is in the candidate list 112, by determining whether the position, at which the logical address LBA is inserted, is retrieved from the candidate hash table 114.

The host 200 may communicate with the storage device 100 via various interfaces. In an embodiment of the inventive concept, the host 200 may be implemented by an application processor (AP) or a system-on-a-chip (SoC).

The host 200 may transmit, to the controller 110, a request for writing data on the NVM 120 or reading data stored in the NVM 120. In this case, the host 200 may transmit a logical address LBA corresponding to a physical address of the NVM 120, at which the data is to be written or read, together with the request.

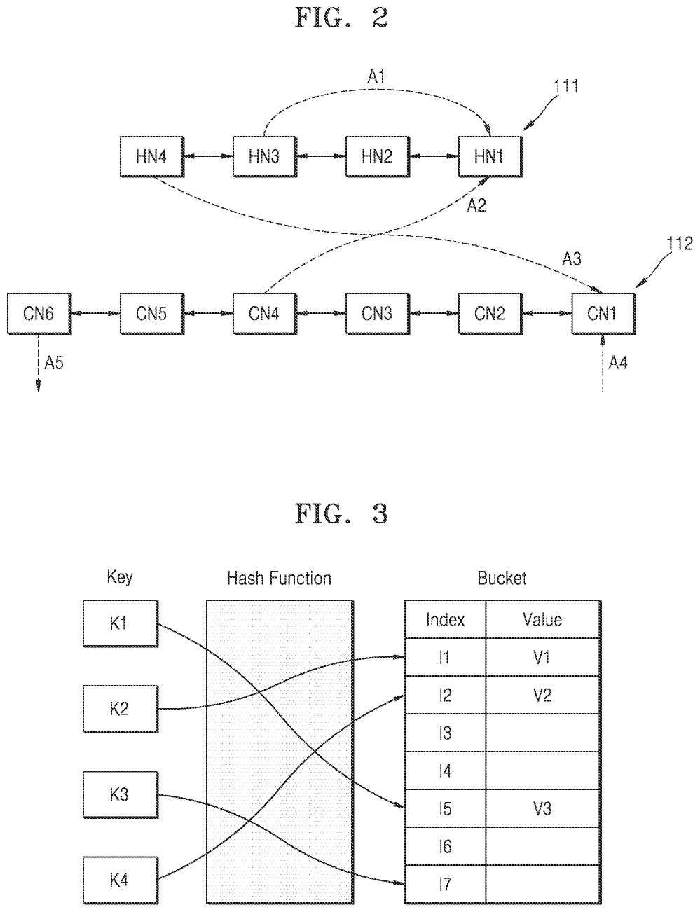

FIG. 2 is a diagram for reference in describing the hot list 111 and the candidate list 112 according to an embodiment of the inventive concept.

Referring to FIG. 2, an example of the hot list 111 is shown at the top of the drawing, and an example of the candidate list 112 is shown at the bottom of the drawing.

The hot list 111 may include a plurality of hot nodes, e.g., first to fourth hot nodes HN1 to HN4. Herein, a logical address LBA of a region in which hot data is stored may be inserted into each node.

In an embodiment of the inventive concept, the controller 110 may store logical addresses LBA in the hot list 111 by a first-in first-out scheme. For example, a logical address LBA newly inserted into the hot list 111 may be inserted into the first hot node HN1. In this case, a logical address LBA already inserted into the first hot node HN1 may be shifted to the second hot node HN2. In addition, a logical address LBA already inserted into the second hot node HN2 may be shifted to the third hot node HN3, and a logical address LB A already inserted into the third hot node HN3 may be shifted to the fourth hot node HN4. In addition, there is no hot node to which a logical address LBA already inserted into the fourth hot node HN4 is to be shifted, and this logical address LBA is the oldest one received from the host 200, and thus, this logical address LBA may be removed.

In an embodiment of the inventive concept, the hot list 111 may have a double connection list structure in which hot nodes are bidirectionally connected. That is, the controller 110 may store logical addresses LBAs in the hot list 111 in the double connection list structure. When logical addresses LBA are stored in the double connection list structure, if a new logical address LBA is inserted into the hot list 111, a computation according to the insertion of the new logical address LBA may be reduced by changing only a connection between hot nodes instead of shifting a logical address LBA stored in each hot node. As described above, by storing a logical address LBA of a region in which hot data is stored in the double connection list structure, an operation required to manage the hot list 111 may be relatively efficiently performed.

The candidate list 112 may include a plurality of candidate nodes, e.g., first to sixth candidate nodes CN1 to CN6. Herein, a logical address LBA of a region in which warm data is stored may be inserted into each node.

In an embodiment of the inventive concept, the controller 110 may store logical addresses LBA in the candidate list 112 by the first-in first-out scheme. For example, a logical address LBA newly inserted into the candidate list 112 may be inserted into the first candidate node CN1. In addition, when a logical address LBA is supposed to be removed from the candidate list 112, the oldest logical address LBA inserted into the sixth candidate node CN6 may be removed.

In this case, a logical address LBA already inserted into the first candidate node CN1 may be shifted to the second candidate node CN2. In addition, a logical address LBA already inserted into the second candidate node CN2 may be shifted to the third candidate node CN3, a logical address LBA already inserted into the third candidate node CN3 may be shifted to the fourth candidate node CN4, a logical address LBA already inserted into the fourth candidate node CN4 may be shifted to the fifth candidate node CN5, and a logical address LBA already inserted into the fifth candidate node CN5 may be shifted to the sixth candidate node CN6. In addition, there is no candidate node to which a logical address LBA already inserted into the sixth candidate node CN6 is to be shifted, and this logical address LBA is the oldest one received from the host 200, and thus, this logical address LBA may be removed.

In an embodiment of the inventive concept, the candidate list 112 may have the double connection list structure in which candidate nodes are bidirectionally connected. That is, the controller 110 may store logical addresses LBA in the candidate list 112 in the double connection list structure. When logical addresses LBA are stored in the double connection list structure, in the case where a new logical address LBA is inserted into the candidate list 112, a computation according to the insertion of the new logical address LBA may be reduced by changing only a connection between candidate nodes instead of shifting a logical address LBA stored in each candidate node. As described above, by storing a logical address LBA of a region in which warm data is stored in the double connection list structure, an operation required to manage the candidate list 112 may be relatively efficiently performed.

When a received logical address LBA is the same as a logical address LBA included in the hot list 111, the controller 110 may remove the logical address LBA included in the hot list 111 and re-insert the received logical address LBA into the hot list 111. For example, when the received logical address LBA is the same as a logical address LBA inserted into the third hot node HN3, the controller 110 may remove the logical address LBA inserted into the third hot node HN3 and re-insert the received logical address LBA into the first hot node HN1. That is, this may be the same as shifting a logical address LBA as indicated by arrow A1 in the FIG. 2.

When a received logical address LBA is the same as a logical address LBA included in the candidate list 112, the controller 110 may remove the logical address LBA included in the candidate list 112 and re-insert the received logical address LBA into the hot list 111. For example, when the received logical address LBA is the same as a logical address LBA inserted into the fourth candidate node CN4, the controller 110 may remove the logical address LBA inserted into the fourth candidate node CN4 and re-insert the received logical address LBA into the first hot node HN1. That is, this may be the same as shifting a logical address LBA as indicated by arrow A2 in the FIG. 2.

As described above, when a logical address LBA inserted into the candidate list 112 is inserted into the first hot node HN1, in the case where the hot list 111 is in a full state in which logical addresses LBA are inserted into all hot nodes, the controller 110 may remove the oldest logical address LBA inserted into the hot list 111. In addition, the controller 110 may insert, into the candidate list 112, the logical address LBA removed from the hot list 111. For example, when a new logical address LBA is supposed to be inserted into the hot list 111 when the hot list 111 is in the full state, the controller 110 may remove a logical address LBA inserted into the fourth hot node HN4 and insert the removed logical address LBA into the first candidate node CN1. That is, this may be the same as shifting a logical address LBA as indicated by arrow A3 in the FIG. 2.

When a received logical address LBA is the same as a logical address LBA included neither in the hot list 111 nor in the candidate list 112, the controller 110 may insert the received logical address LBA into the candidate list 112. For example, when the received logical address LBA is the same as a logical address LBA included neither in the hot list 111 nor in the candidate list 112, the received logical address LBA may be inserted into the first candidate node CN1. That is, this may be the same as inserting a logical address LBA as indicated by arrow A4 in the FIG. 2.

As described above, when a logical address LBA is inserted into the first candidate node CN1, in the case where the candidate list 112 is in the full state in which logical addresses LBA are inserted into all candidate nodes, the controller 110 may remove the oldest logical address LBA inserted into the candidate list 112. For example, when a new logical address LBA is supposed to be inserted into the candidate list 112 when the candidate list 112 is in the full state, the controller 110 may remove a logical address LBA inserted into the sixth candidate node CN6. That is, this may be the same as removing a logical address LBA as indicated by arrow A5 in the FIG. 2.

FIG. 3 is diagram for reference in describing a hash table according to an embodiment of the inventive concept.

Referring to FIG. 3, a basic structure of the hash table is illustrated. The hot hash table 113 and the candidate hash table 114 managed by the controller 110 may have a structure as shown in FIG. 3.

The hash table has a data structure in which data is stored based on a key and a value, and when a key is input to the hash table, a value corresponding to the key may be output. Herein, the hash table may store values by using a bucket. Therefore, upon receiving a key, the controller 110 may convert the key through a hash function to obtain an index, and obtain or store a value corresponding to the key from or in a region in the bucket corresponding to the obtained index.

For example, upon receiving K2 as a key, the controller 110 may obtain I1 as an index by converting K2 through the hash function. Thereafter, the controller 110 may obtain V1, which is a value stored in a region in the bucket corresponding to I1.

As another example, upon receiving K3 as a key, the controller 110 may obtain 17 as an index by converting K3 through the hash function. Thereafter, the controller 110 may store a desired value in a corresponding region or, in the case of FIG. 3, may not return a value, because there is no value stored in a region in the bucket corresponding to 17.

As described above, because a value corresponding to a key is retrieved from the hash table by using the hash function, data corresponding to the key may be quickly retrieved.

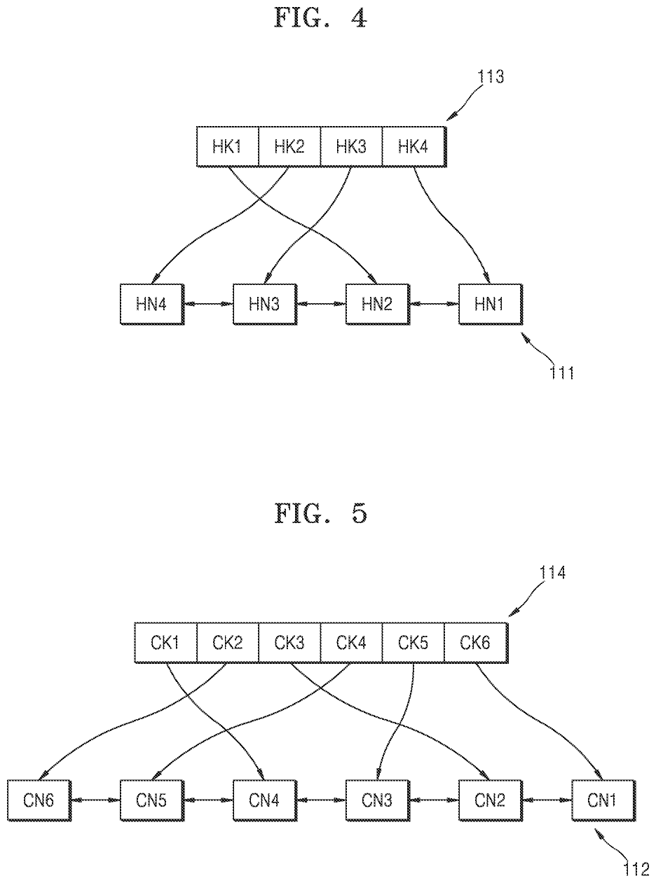

FIG. 4 is a diagram for reference in describing the hot list 111 and the hot hash table 113 according to an embodiment of the inventive concept.

Referring to FIG. 4, a relationship between the hot list 111 and the hot hash table 113 is shown. The hot hash table 113 is shown based on a key for convenience of the depiction.

The hot hash table 113 may store positions, at which logical addresses LBA are stored in the hot list 111. Therefore, the controller 110 may retrieve a position, at which a logical address LBA is inserted into the hot list 111, by using the hot hash table 113.

In this case, the controller 110 may use the logical address LBA as a key. That is, upon receiving a logical address LBA from the host 200, the controller 110 may convert the received logical address LBA through a hot hash function, which is a hash function of the hot hash table 113, to obtain a hot index, which is an index of a bucket of the hot hash table 113. In addition, the controller 110 may retrieve a position, at which the logical address LBA is inserted into the hot list 111, from a region of the hot hash table 113 corresponding to the hot index.

In the embodiment of FIG. 4, upon receiving HK3 as a logical address LBA, the controller 110 may obtain a hot index by converting HK3 through the hot hash function and retrieve, as HN3, a position, at which the logical address LBA is inserted, from a region corresponding to the obtained hot index.

As described above, the controller 110 may determine whether a logical address LBA is inserted into the hot list 111, by using the hot hash table 113, thereby determining an attribute of data at a relatively fast speed.

When no logical address LBA is inserted into the hot list 111, no value may be in a region corresponding to a hot index obtained by converting a logical address LBA through the hot hash function. Therefore, the controller 110 may determine whether a logical address LBA is inserted into the hot list 111, by using the hot hash table 113. In this case, the controller 110 may determine whether a logical address LBA is inserted into the candidate list 112, by using the candidate hash table 114. Hereinafter, a method of determining whether a logical address LBA is inserted into the candidate list 112 is described.

FIG. 5 is a diagram for reference in describing the candidate list 112 and the candidate hash table 114 according to an embodiment of the inventive concept.

Referring to FIG. 5, a relationship between the candidate list 112 and the candidate hash table 114 is shown. The candidate hash table 114 is shown based on a key for convenience of the depiction.

The candidate hash table 114 may store positions, at which logical addresses LBA are stored in the candidate list 112. Therefore, the controller 110 may retrieve a position, at which a logical address LBA is inserted into the candidate list 112, by using the candidate hash table 114.

In this case, the controller 110 may use the logical address LBA as a key. That is, upon receiving a logical address LBA from the host 200, the controller 110 may convert the received logical address LBA through a candidate hash function, which is a hash function of the candidate hash table 114, to obtain a candidate index, which is an index of a bucket of the candidate hash table 114. In addition, the controller 110 may retrieve a position, at which the logical address LBA is inserted into the candidate list 112, from a region of the candidate hash table 114 corresponding to the candidate index.

In the embodiment of FIG. 5, upon receiving CK5 as a logical address LBA, the controller 110 may obtain a candidate index by converting CK5 through the candidate hash function and retrieve, as CN3, a position, at which the logical address LBA is inserted, from a region corresponding to the obtained candidate index.

When no logical address LBA is inserted into the candidate list 112, no value may be in a region corresponding to a candidate index obtained by converting a logical address LBA through the candidate hash function. Therefore, the controller 110 may determine whether a logical address LBA is inserted into the candidate list 112, by using the candidate hash table 114. As described above, the controller 110 may determine whether a logical address LBA is inserted into the candidate list 112, by using the candidate hash table 114, thereby determining an attribute of data at a relatively fast speed.

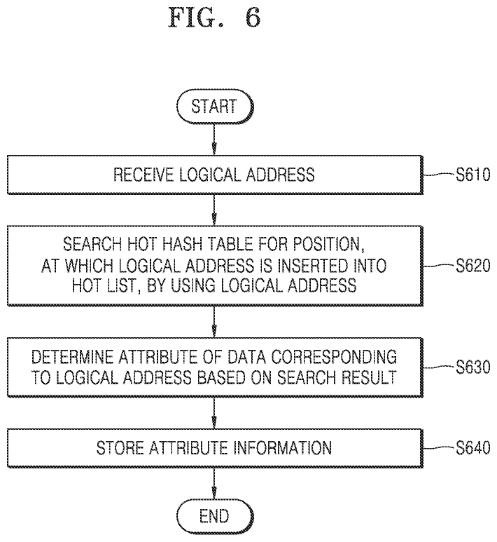

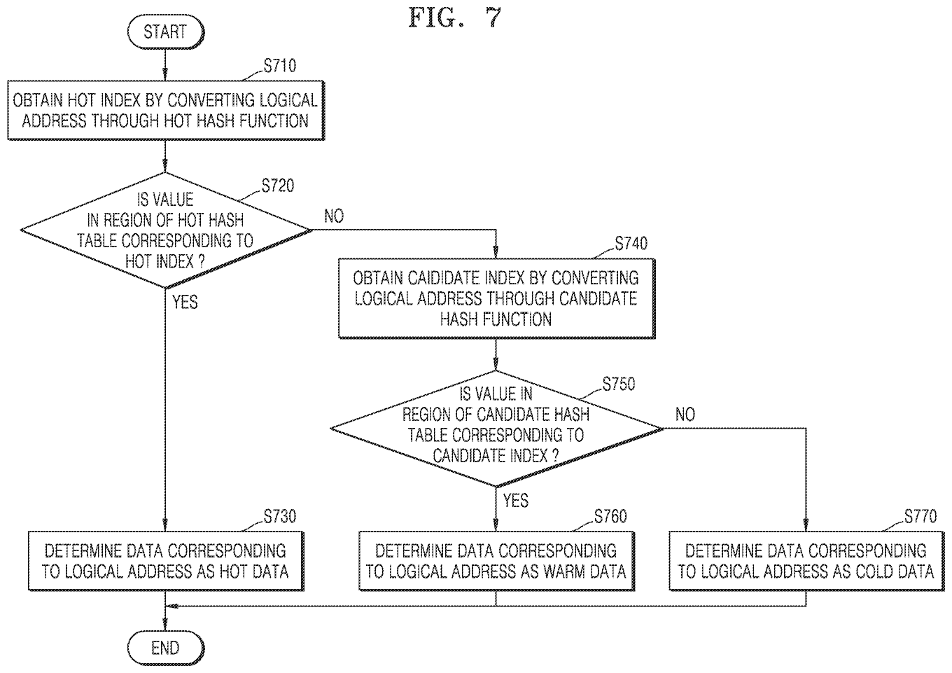

FIG. 6 is a flowchart illustrating an operating method of a storage device, according to an embodiment of the inventive concept.

Referring to FIG. 6, the controller 110 may receive a logical address LBA from the host 200 in operation S610. The logical address LBA may correspond to a request from the host 200 to write data on the NVM 120 or read data stored in the NVM 120.

In operation S620, the controller 110 may search for a position, at which the logical address LBA is inserted into the hot list 111, in the hot hash table 113 by using the logical address LBA.

The controller 110 may obtain a hot index by converting the logical address LBA through a hot hash function and search for the position, at which the logical address LBA is inserted into the hot list 111, in a region corresponding to the obtained hot index.

In operation S630, the controller 110 may determine an attribute of data corresponding to the logical address LBA based on the search result.

In the case where the position, at which the logical address LBA is inserted into the hot list 111, is retrieved from the hot hash table 113, the controller 110 may determine, as hot, the attribute of the data corresponding to the logical address LBA. That is, the controller 110 may determine, as hot data, the data corresponding to the logical address LBA.

Otherwise, in the case where the position, at which the logical address LBA is inserted into the hot list 111, is not retrieved from the hot hash table 113, the controller 110 may determine, as warm or cold, the attribute of the data corresponding to the logical address LBA. In this case, the controller 110 may retrieve a position, at which the logical address LBA is inserted into the candidate list 112, from the candidate hash table 114 to determine whether the attribute of the data is warm or cold.

The controller 110 may obtain a candidate index by converting the logical address LBA through a candidate hash function and search for the position, at which the logical address LBA is inserted into the candidate list 112, from a region corresponding to the obtained candidate index.

In the case where the position, at which the logical address LBA is inserted into the candidate list 112, is retrieved from the candidate hash table 114, the controller 110 may determine, as warm, the attribute of the data corresponding to the logical address LBA. That is, the controller 110 may determine, as warm data, the data corresponding to the logical address LBA.

Otherwise, in the case where the position, at which the logical address LBA is inserted into the candidate list 112, is not retrieved from the candidate hash table 114, the controller 110 may determine, as cold, the attribute of the data corresponding to the logical address LBA. That is, the controller 110 may determine, as cold data, the data corresponding to the logical address LBA.

In operation S640, the controller 110 may store attribute information indicating the attribute of the data. Herein, the attribute information may be stored in the NVM 120 or in a separate random access memory (RAM) embedded in the storage device 100.

The controller 110 may store the attribute of the data, which is determined in operation S630, as the attribute information. The controller 110 may use the stored attribute information in an operation, such as garbage collection.

FIG. 7 is a flowchart illustrating a method, performed by a storage device, of determining an attribute of data corresponding to a received logical address, according to an embodiment of the inventive concept.

Referring to FIG. 7, in operation S710, the controller 110 may obtain a hot index by converting a logical address LBA through a hot hash function.

The controller 110 may use the logical address LBA as a key of the hot hash table 113. Therefore, the controller 110 may obtain the hot index of a bucket in the hot hash table 113 by converting the logical address LBA through the hot hash function.

In operation S720, the controller 110 may determine whether a value is in a region of the hot hash table 113 corresponding to the hot index.

In the case where it is determined that a value is in the region of the hot hash table 113 corresponding to the hot index, the method may proceed to operation S730, and the controller may determine, as hot data, data corresponding to the logical address LBA.

Otherwise, in the case where it is determined that no value is in the region of the hot hash table 113 corresponding to the hot index, the method may proceed to operation S740, and the controller 110 may obtain a candidate index by converting the logical address LBA through a candidate hash function.

The controller 110 may use the logical address LBA as a key of the candidate hash table 114. Therefore, the controller 110 may obtain the candidate index of a bucket in the candidate hash table 114 by converting the logical address LBA through the candidate hash function.

In operation S750, the controller 110 may determine whether a value is in a region of the candidate hash table 114 corresponding to the candidate index.

In the case where it is determined that a value is in the region of the candidate hash table 114 corresponding to the candidate index, the method may proceed to operation S760, and the controller 110 may determine, as warm data, the data corresponding to the logical address LBA.

Otherwise, in the case where it is determined that no value is in the region of the candidate hash table 114 corresponding to the candidate index, the method may proceed to operation S770, and the controller 110 may determine, as cold data, the data corresponding to the logical address LBA.

As described above, the storage device 100 according to the inventive concept determines an attribute of data by using the hot hash table 113 and the candidate hash table 114, and thus, the storage device 100 may quickly determine an attribute of data corresponding to a logical address LBA received from the host 200.

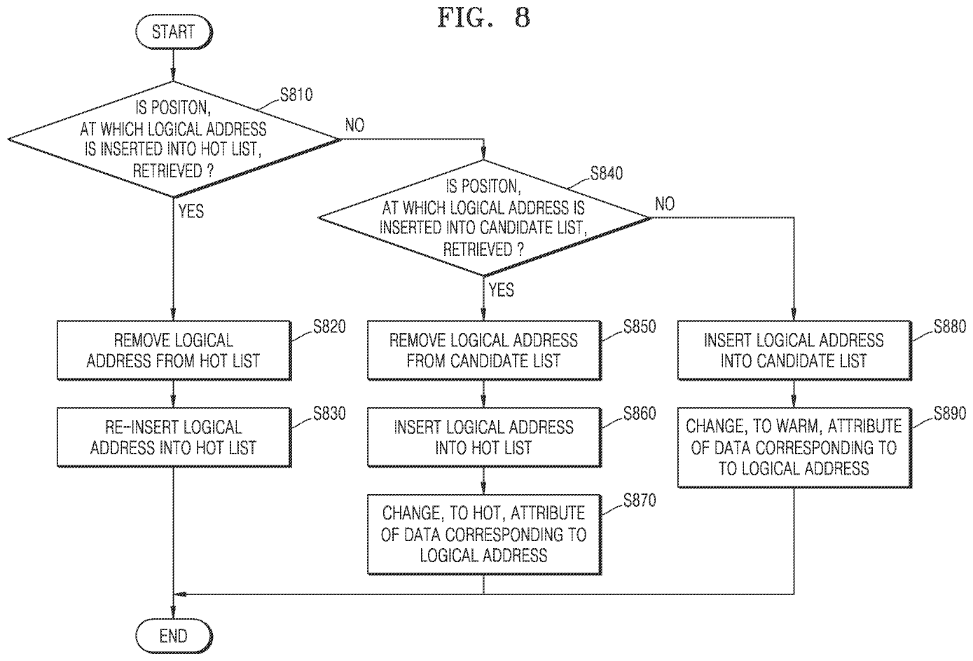

FIG. 8 is a flowchart illustrating a method, performed by a storage device, of updating a hot list or a candidate list, according to an embodiment of the inventive concept.

Referring to FIG. 8, in operation S810, the controller 110 may determine whether a position, at which a logical address LBA is inserted into the hot list 111, is retrieved.

The controller 110 may determine whether the position, at which the logical address LBA is inserted into the hot list 111, is retrieved, by determining whether a value is in a region of the hot hash table 113 corresponding to a hot index.

In the case where the position, at which the logical address LBA is inserted into the hot list 111, is retrieved from the hot hash table 113, the controller 110 may determine, as hot, an attribute of data corresponding to the logical address LBA. Then, the method may proceed to operation S820, and the controller 110 may remove the logical address LBA from the hot list 111. Thereafter, in operation S830, the controller 110 may re-insert the logical address LBA in the hot list 111. As described above, when there is a read or write request for a logical address LBA in the hot list 111, the logical address LBA may be removed from the hot list 111 and re-inserted into the hot list 111 to prevent the logical address LBA from being wrongly removed from the hot list 111 of the first-in first-out scheme.

In the case where the position, at which the logical address LBA is inserted into the hot list 111, is not retrieved from the hot hash table 113, the method may proceed to operation S840, and the controller 110 may determine whether a position, at which the logical address LBA is inserted into the candidate list 112, is retrieved.

In the case where the position, at which the logical address LBA is inserted into the candidate list 112, is retrieved from the candidate hash table 114, the controller 110 may determine, as warm, the attribute of the data corresponding to the logical address LBA. Then, the method may proceed to operation S850, and the controller 110 may remove the logical address LBA from the candidate list 112. Thereafter, in operation S860, the controller 110 may insert the logical address LBA into the hot list 111. Thereafter, in operation S870, the controller 110 may change, as hot, the attribute of the data corresponding to the logical address LBA. As described above, when there is a read or write request for a logical address LBA in the candidate list 112, the logical address LBA may be moved from the candidate list 112 to the hot list 111 to change an attribute of data.

In the case where the position, at which the logical address LBA is inserted into the candidate list 112, is not retrieved from the candidate hash table 114, the controller 110 may determine, as cold, the attribute of the data corresponding to the logical address LBA. Then, the method may proceed to operation S880, and the controller 110 may insert the logical address LBA into the candidate list 112. Thereafter, in operation S890, the controller 110 may change, as warm, the attribute of the data corresponding to the logical address LBA. As described above, when there is a read or write request for a logical address LBA in the hot list 111 and the candidate list 112, the logical address LBA may be inserted into the candidate list 112 to change an attribute of data.

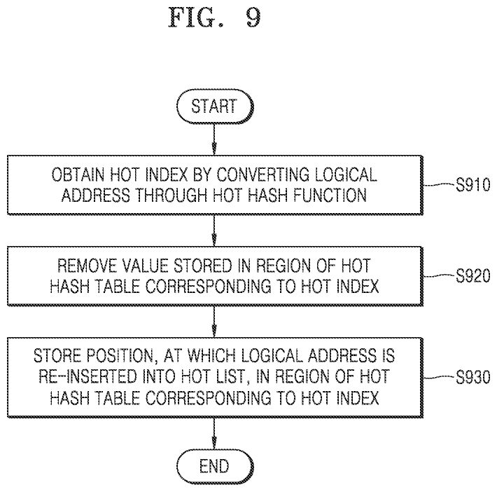

FIG. 9 is a flowchart illustrating a method, performed by a storage device, of updating a hot hash table when a received logical address is in a hot list, according to an embodiment of the inventive concept.

Referring to FIG. 9, a method of updating the hot hash table 113 when the hot list 111 is updated by retrieving a position, at which a logical address LBA is inserted into the hot list 111, is illustrated.

First, in operation S910, the controller 110 may obtain a hot index by converting a logical address LBA through a hot hash function.

In operation S920, the controller 110 may remove a value stored in a region of the hot hash table 113 corresponding to the hot index. Operation S920 may include updating the hot hash table 113, which corresponds to operation S820 (FIG. 8) of removing the logical address LBA from the hot list 111.

In operation S930, the controller 110 may store a position, at which the logical address LBA is re-inserted into the hot list 111, in a region of the hot hash table 113 corresponding to the hot index. Operation S930 may include updating the hot hash table 113, which corresponds to operation S830 (FIG. 8) of re-inserting the logical address LBA into the hot list 111.

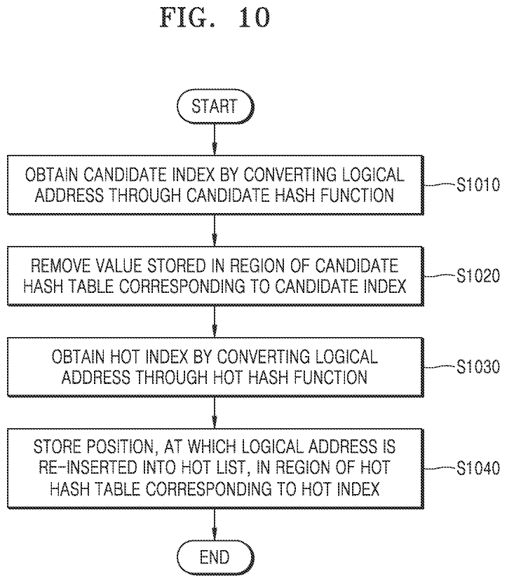

FIG. 10 is a flowchart illustrating a method, performed by a storage device, of updating a hot hash table and a candidate hash table when a received logical address is in a candidate list, according to an embodiment of the inventive concept.

Referring to FIG. 10, a method of updating the hot hash table 113 and the candidate hash table 114 when the hot list 111 and the candidate list 112 are updated by retrieving a position, at which a logical address LBA is inserted into the hot list 111, is illustrated.

First, in operation S1010, the controller 110 may obtain a candidate index by converting a logical address LBA through a candidate hash function.

In operation S1020, the controller 110 may remove a value stored in a region of the candidate hash table 114 corresponding to the candidate index. Operation S1020 may include updating the candidate hash table 114, which corresponds to operation S850 (FIG. 8) of removing the logical address LBA from the candidate list 112.

In operation S1030, the controller 110 may obtain a hot index by converting the logical address LBA through a hot hash function.

In operation S1040, the controller 110 may store a position, at which the logical address LBA is inserted into the hot list 111, in a region of the hot hash table 113 corresponding to the hot index. Operation S1040 may include updating the hot hash table 113, which corresponds to operation S860 (FIG. 8) of inserting the logical address LBA into the hot list 111.

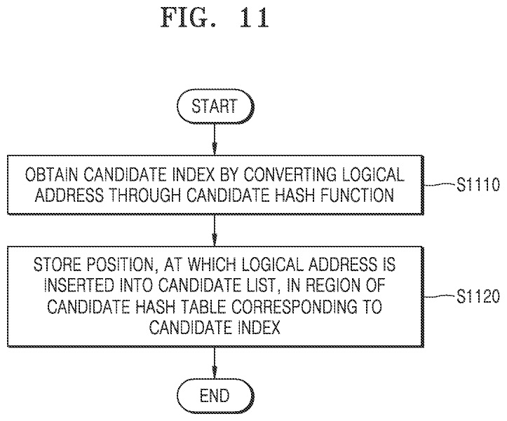

FIG. 11 is a flowchart illustrating a method, performed by a storage device, of updating a candidate hash table when a received logical address is neither in a hot list nor in a candidate list, according to an embodiment of the inventive concept.

Referring to FIG. 11, a method of updating the candidate hash table 114 when the candidate list 112 is updated because both positions, at which a logical address LBA is inserted into the hot list 111 and the candidate list 112, are not retrieved is illustrated.

First, in operation S1110, the controller 110 may obtain a candidate index by converting a logical address LBA through a candidate hash function.

In operation S1120, the controller 110 may store a position, at which the logical address LBA is inserted into the candidate list 112, in a region of the candidate hash table 114 corresponding to the candidate index. Operation S1120 may include updating the candidate hash table 114, which corresponds to operation S880 (FIG. 8) of inserting the logical address LBA into the candidate list 112.

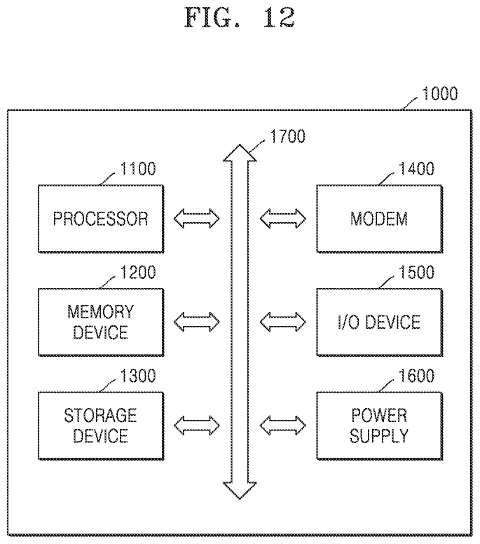

FIG. 12 is a block diagram illustrating an electronic device 1000 according to an embodiment of the inventive concept.

Referring to FIG. 12, the electronic device 1000 may include a processor 1100, a memory device 1200, a storage device 1300, a modem 1400, an input/output (I/O) device 1500, and a power supply 1600, all communicating over a bus system 1700. Herein, the storage device 1300 may be implemented by the storage device of FIG. 1. In addition, a controller of the storage device 1300 may manage a hot list, a candidate list, a hot hash table, and a candidate hash table in according with embodiments of the inventive concept.

In an embodiment of the inventive concept, according to the storage device 1300, it may be determined whether a logical address LBA received from a host is included in the hot list and the candidate list, by using the hot hash table and the candidate hash table. Accordingly, an attribute of data may be determined at a relatively fast speed, thereby improving the performance of the storage device 1300.

While the inventive concept has been particularly shown and described with reference to embodiments thereof, it will be understood that various changes in form and details may be made therein without departing from the spirit and scope of the following claims.

What is claimed is:

1. A storage device comprising:
a nonvolatile memory; and
a controller configured to insert, into a hot list, a portion of a logical address received from a host, and manage a hot hash table storing a position at which the logical address is inserted into the hot list,
wherein the controller is further configured to search the hot hash table for the position, at which the logical address is inserted into the hot list, by using the logical address, determine an attribute of data corresponding to the logical address based on the search result, and store attribute information indicating the attribute of the data.

2. The storage device of claim 1, wherein the controller is further configured to obtain a hot index by converting the logical address through a hot hash function, search for the position, at which the logical address is inserted into the hot list, in a region of the hot hash table corresponding to the hot index, and determine data corresponding to the logical address as hot data if the position, at which the logical address is inserted into the hot list, is retrieved.

3. The storage device of claim 1, wherein the controller is further configured to, when the position, at which the logical address is inserted into the hot list, is retrieved, remove the logical address from the hot list and re-insert the logical address into the hot list.

4. The storage device of claim 3, wherein the controller is further configured to, when the position, at which the logical address is inserted into the hot list, is retrieved, obtain a hot index by converting the logical address through a hot hash function, remove a value stored in a region of the hot hash table corresponding to the hot index, and store a position, at which the logical address is re-inserted into the hot list, in the region of the hot hash table corresponding to the hot index.

5. The storage device of claim 1, wherein the controller is further configured to insert the portion of the logical address into a candidate list and manage a candidate hash table storing a position at which the logical address is inserted into the candidate list.

6. The storage device of claim 5, wherein the controller is further configured to, when the logical address is not retrieved from the hot list, search for a position, at which the logical address is inserted into the candidate list, in the candidate hash table by using the logical address, determine an attribute of data corresponding to the logical address, and store attribute information indicating the attribute of the data.

7. The storage device of claim 6, wherein the controller is further configured to obtain a candidate index by converting the logical address through a candidate hash function, search for the position, at which the logical address is inserted into the candidate list, in a region of the candidate hash table corresponding to the candidate index, determine the data corresponding to the logical address as warm data when the position, at which the logical address is inserted into the candidate list, is retrieved, and determine the data corresponding to the logical address as cold data when the position, at which the logical address is inserted into candidate list, is not retrieved.

8. The storage device of claim 6, wherein the controller is further configured to, when the position, at which the logical address is inserted into the candidate list, is retrieved, remove the logical address from the candidate list, insert the logical address into the hot list, and change, to hot, the attribute of the data corresponding to the logical address.

9. The storage device of claim 8, wherein the controller is further configured to obtain a candidate index by converting the logical address through a candidate hash function, remove a value stored in a region of the candidate hash table corresponding to the candidate index, obtain a hot index by converting the logical address through a hot hash function, and store the position, at which the logical address is inserted into the hot list, in a region of the hot hash table corresponding to the hot index.

10. The storage device of claim 6, wherein the controller is further configured to, when the position, at which the logical address is inserted into the candidate list, is not retrieved, insert the logical address into the candidate list and change, to warm, the attribute of the data corresponding to the logical address.

11. The storage device of claim 10, wherein the controller is further configured to obtain a candidate index by converting the logical address through a candidate hash function and store the position, at which the logical address is inserted into the candidate list, in a region of the candidate hash table corresponding to the candidate index.

12. The storage device of claim 5, wherein the controller is further configured to store the logical address in the hot list and the candidate list in a double connection list structure.

13. The storage device of claim 5, wherein the controller is further configured to store the logical address in the hot list and the candidate list in a first-in first-out scheme.

14. An operating method of a storage device comprising a nonvolatile memory and a controller, the operating method comprising:
receiving a logical address from a host under control of the controller;
searching a hot hash table for a position, at which the logical address is inserted into a hot list, by using the logical address under control of the controller;
determining an attribute of data corresponding to the logical address based on the search result under control of the controller; and
storing attribute information indicating the attribute of the data under control of the controller.

15. The operating method of claim 14, wherein the determining the attribute of the data corresponding to the logical address comprises determining, under control of the controller, the data corresponding to the logical address as hot data if the position, at which the logical address is inserted into the hot list, is retrieved.

16. The operating method of claim 14, further comprising:
removing, under control of the controller, the logical address from the hot list when the position, at which the logical address is inserted into the hot list, is retrieved; and
re-inserting the logical address into the hot list under control of the controller.

17. The operating method of claim 14, wherein the determining the attribute of the data corresponding to the logical address comprises:
searching, under control of the controller, a candidate hash table for a position, at which the logical address is inserted into a candidate list when the position, at which the logical address is inserted into the hot list, is not retrieved;
determining, under control of the controller, the data corresponding to the logical address as warm data when the position, at which the logical address is inserted into the candidate list, is retrieved; and
determining, under control of the controller, the data corresponding to the logical address as cold data when the position, at which the logical address is inserted into the candidate list, is not retrieved.

18. The operating method of claim 17, further comprising:
removing, under control of the controller, the logical address from the candidate list when the position, at which the logical address is inserted into the candidate list, is retrieved;
inserting the logical address into the hot list under control of the controller; and
changing, to hot, the attribute of the data corresponding to the logical address under control of the controller.

19. The operating method of claim 17, further comprising:
inserting, under control of the controller, the logical address into the candidate list when the position, at which the logical address is inserted into the candidate list, is not retrieved; and
changing, to warm, the attribute of the data corresponding to the logical address under control of the controller.

20. A storage system comprising:
a storage device including a nonvolatile memory and a controller configured to manage a hot list and a hot hash table; and
a host configured to transmit a logical address to the storage device,
wherein the controller is further configured to search the hot hash table for the position, at which the logical address is inserted into the hot list, by using the logical address, determine an attribute of data corresponding to the logical address based on the search result, and store attribute information indicating the attribute of the data.
